(19) United States
(12) Patent Application Publication
(10) Pub. No.: US 2013/0305656 A1
(43) Pub. Date: Nov. 21, 2013

(54) SPACER, CONNECTOR AND INSULATING GLAZING UNIT

(71) Applicant: Xavier Ripoche, Roiffieux (FR)

(72) Inventor: Xavier Ripoche, Roiffieux (FR)

(73) Assignee: Saint- Gobain Glass France, Courbevoie (FR)

(21) Appl. No.: 13/982,660

(22) PCT Filed: Jan. 30, 2012
(86) PCT No.: PCT/FR2012/050185

§ 371 Date: Jul. 30, 2013

(30) Foreign Application Priority Data
Feb. 8, 2011 (FR) 1150991

(51) Int. Cl. E06B 3/667

(52) U.S. Cl. CPC E06B 3/667
USPC 52/786.13; 403/205

(57) ABSTRACT

A spacer for an insulating glazing unit, the spacer including a longitudinal body including two longitudinal sides and two membranes or membrane parts, each membrane or membrane part configured to be secured to a glass sheet of the insulating glazing unit, and each membrane or membrane part configured to be articulated to the body about an axis parallel to the longitudinal axis of the body between a position in which the membrane or membrane part lies against a longitudinal side of the body and a position in which the membrane or membrane part is at least partially moved apart from the longitudinal side of the body. The spacer allows the size of the insulating glazing unit not to be restricted while ensuring a bead for example of butyl of the insulating glazing unit can withstand high climatic loads without being damaged.

The invention relates to a spacer for an insulating glazing unit, or to a right-angle connector for connecting two spacers of an insulating glazing unit, and to an insulating glazing unit comprising at least two glass sheets and at least one spacer placed between the glass sheets.

A spacer for an insulating glazing unit is customarily made of metal, for example of aluminum or steel, or of a composite, for example a combination of plastic and metal. To produce an insulating glazing unit, a bead of butyl is deposited on the sides of the spacer that forms a frame of any shape, and then the butyl-coated frame is placed between two glass sheets. The bead of butyl both secures the spacer to the glass sheets, so as to seal the insulating glazing unit, and forms a first barrier to gas and water vapor. A polyurethane, polysulfide or silicone mastic is then applied between the glass sheets of the insulating glazing unit, externally to the spacer, between the spacer edge oriented toward the exterior of the glazing and the edge face of the glass sheets, thereby forming a second barrier to gas and water-vapor.

However, when an insulating glazing unit is subjected to climatic loads or wind loads, it deforms. For example, the glazing unit expands under the effect of solar heating. When an insulating glazing unit equipped with a spacer such as described above deforms under the effect of climatic loads, the bead of butyl also deforms, which deformation, if it is substantial, can damage the bead of butyl. This degrades the seal of the insulating glazing unit, then resulting in reduced thermal insulation performance from the insulating glazing unit if air penetrates into the insulating glazing unit and replaces a gas such as argon, and/or reduced visibility, if water vapor penetrates between the glass sheets and condenses on the glass sheets inside the insulating glazing unit.

To prevent this problem of damage to the bead of butyl, it is known to restrict the size of insulating glazing units so as not to mechanically stress the sealing barriers formed by the mastic and the bead of butyl by more than a maximum level. However, the possible size of the insulating glazing unit is then limited. Thus, for triple glazing units of width below 800 mm, or with gas-filled cavities of thickness above 12 mm or even with glass sheets of thickness above 6 mm or laminated glass, the mechanical stress generated in the bead of butyl may be high, resulting in the bead of butyl being damaged and the seal of the insulating glazing unit being broken.

There is therefore a need for a spacer, for an insulating glazing unit, which does not restrict the size of the insulating glazing unit while ensuring that the bead of butyl of the insulating glazing unit can withstand high climatic loads or wind loads without being damaged.

For this purpose, the invention provides a spacer for an insulating glazing unit, the spacer comprising a longitudinal body provided with two longitudinal sides and two membranes or membrane parts, each membrane or membrane part being intended to be secured to a glass sheet of the insulating glazing unit, and each membrane or membrane part being adapted to be articulated to the body about an axis parallel to the longitudinal axis of the body between a position in which the membrane or membrane part lies against a longitudinal side of the body and a position in which the membrane or membrane part is at least partially a spaced apart from the longitudinal side of the body.

According to another feature, each membrane or membrane part is accordion- or bellows-shaped, the accordion or bellows having at least one fold.

According to another feature, each membrane or membrane part is adapted to hinge with the body when the spacer is fitted in an insulating glazing unit.

According to another feature, the body is a hollow profile filled with desiccant.

According to another feature, the body is made of metal or plastic or of a composite.

According to another feature, the membranes or membrane parts are made of metal and/or plastic.

The invention also relates to a right-angle connector for connecting two spacers of an insulating glazing unit, the connector comprising a right-angle body provided with two flanges connected via a corner, the end of each flange being intended to be inserted into a spacer and each flange and each corner being provided with two longitudinal sides, and two membranes or membrane parts each intended to be secured to a glass sheet of the insulating glazing unit, each membrane or membrane part being adapted to be articulated to the flanges and the corner about an axis parallel to the longitudinal axis of the flanges and of the corner between a position in which the membrane or membrane part lies against a longitudinal side of the flanges and of the corner and a position in which the membrane or membrane part is at least partially spaced apart from the longitudinal side of the flanges and of the corner.

According to another feature, each membrane or membrane part is accordion- or bellows-shaped, the accordion or bellows having at least one fold.

According to another feature, each membrane or membrane part is adapted to hinge with the right-angle body when the connector is fitted in an insulating glazing unit.

According to another feature, the right-angle body forms a single hollow profile filled with desiccant.

According to another feature, the right-angle body is made of metal or plastic or of a composite.

According to another feature, the membranes or membrane parts are made of metal and/or plastic.

The invention also relates to an insulating glazing unit which comprises:
at least two glass sheets;
at least one spacer as described above, each membrane or membrane part being secured to one of the glass sheets of the insulating glazing unit; and
a bead of butyl between each membrane or membrane part and a glass sheet,

the bond strength between the bead of butyl and each membrane or membrane part being strictly greater than the bond strength between each membrane or membrane part and the longitudinal sides of the body of the spacer.

According to another feature, the glazing unit furthermore comprises some mastic placed between the glass sheets between the edge of the spacer oriented toward the exterior of the insulating glazing unit and the edge faces of the glass sheets.

According to another feature, the glazing unit comprises four spacers as described above and four connectors as described above, the spacers being connected pairwise by a connector.

Other features and advantages of the invention will now be described with regards the drawings in which:

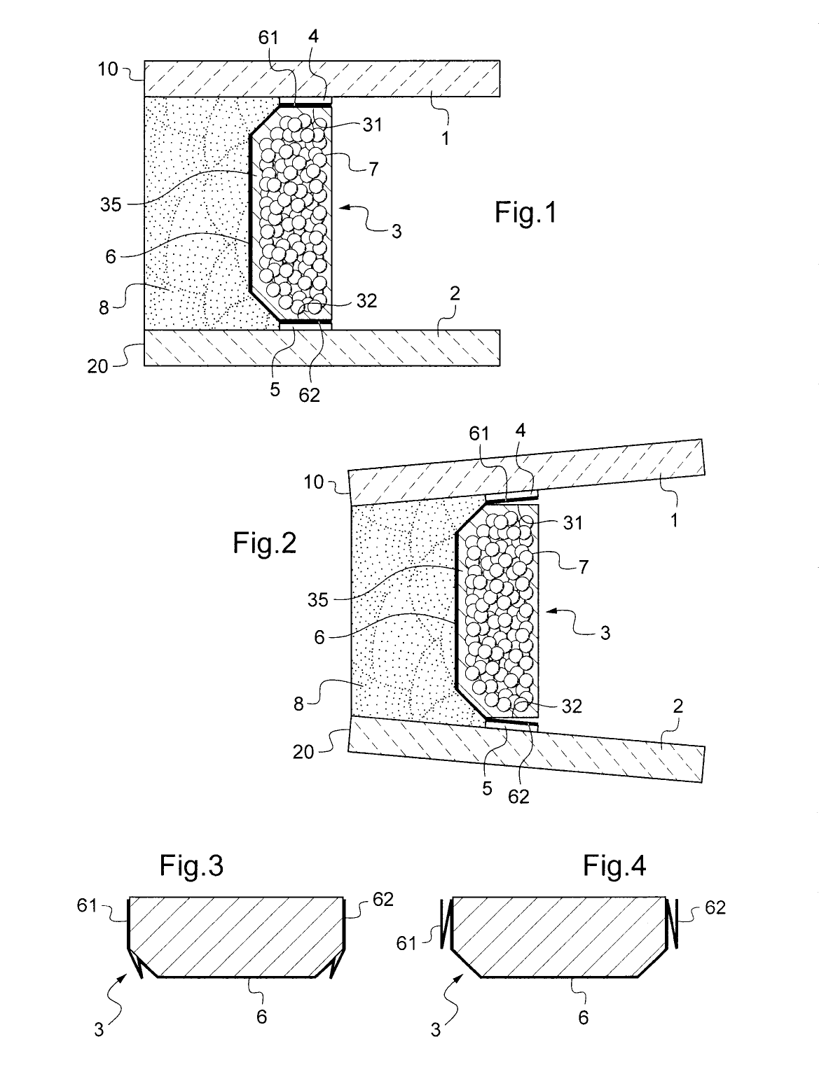

FIG. 1 shows a cross-sectional view of a detail of an insulating glazing unit according to the invention when it is not being deformed, with a spacer according to a first embodiment;

FIG. 2 shows a cross-sectional view of a detail of an insulating glazing unit according to the invention when it is being deformed, with a spacer according to a first embodiment;

FIG. 3 shows a cross-sectional view of a spacer of an insulating glazing unit according to the invention according to a second embodiment;

FIG. 4 shows a cross-sectional view of a spacer of an insulating glazing unit according to the invention according to a third embodiment.

In the various figures, identical reference numbers represent identical or similar elements.

The invention provides a spacer for an insulating glazing unit, the spacer comprising a longitudinal body provided with two longitudinal sides and two membranes or membrane parts each membrane or membrane part being intended to be secured to a glass sheet of the insulating glazing unit. Each membrane or membrane part is adapted to be articulated to the body about an axis parallel to the longitudinal axis of the body between a position in which the membrane or membrane part lies against a longitudinal side of the body and a position in which the membrane or membrane part is at least partially spaced apart from the longitudinal side of the body. Thus, each membrane or membrane part is hinged with the body.

When the insulating glazing unit deforms under the effect of wind loads or climatic loads, the deformation of the glass sheets is compensated for by the membranes or membrane parts which are hinged with the body, the hinge allowing said membranes or membrane parts to move apart from the body at the same time as the bead of butyl that is adhesively bonded between each glass sheet and a membrane or membrane part, so as to follow the movements of the deformed glass sheets. In this way, the bead of butyl is not stressed, or is hardly stressed at all, thereby preventing it from being damaged. This advantage is present whatever the dimensions of the insulating glazing unit. Thus, the hinge function of the membranes or membrane parts of the spacer of an insulating glazing unit allows the size of the insulating glazing unit not to be restricted while ensuring that the bead of butyl of the insulating glazing unit can withstand high climatic loads without being damaged.

FIGS. 1 and 2 show cross-sectional views of a detail of an insulating glazing unit when it is not being deformed, and when it is being deformed, respectively, with a spacer according to the invention fitted in the insulating glazing unit.

The insulating glazing unit comprises at least two glass sheets 1, 2 between which a spacer 3 according to the invention is placed. When the insulating glazing unit comprises more than two glass sheets, a spacer 3 is placed between each pair of two glass sheets. Thus, an insulating triple glazing unit comprises two spacers and an insulating quadruple glazing unit comprises three spacers 3.

The spacer 3 according to the invention comprises a rigid body comprising two longitudinal sides 31, 32, which sides are intended to lie facing a glass sheet 1, of the insulating glazing unit. The spacer 3 also comprises two membranes 61, 62 that are located on the longitudinal sides 31, 32 of the body of the spacer 3. In a variant, the spacer 3 comprises one membrane 6 comprising two parts 61, 62 that are placed on the longitudinal sides 31, 32 of the body of the spacer 3, as shown in the figures. The membrane 6 then has an additional part that connects the two membrane parts 61, 62. This additional part is adhesively bonded to the body of the spacer, to the edge of the body of the spacer, which edge is intended to be oriented toward the exterior of the insulating glazing unit, namely on the same side as the edge faces 10, 20 of the glass sheets 1, 2. The two membranes or membrane parts 61, 62 are adapted to form a hinge with the body, in particular when the spacer 3 is in place in an insulating glazing unit.

The one or more membranes are preferably sealed against gas and water vapor. They are somewhat flexible. The one or more membranes are made of metal (for example aluminum or stainless steel) and/or plastic.

The membranes or membrane parts 61, 62 are attached to the longitudinal sides 31, 32 of the body of the spacer 3 near the edge of the body of the spacer, which edge is intended to be oriented toward the exterior of the insulating glazing unit, namely the same side as the edge faces 10, 20 of the glass sheets 1, 2, and not on the internal side of the insulating glazing unit. The insulating glazing unit comprising the spacer 3 can thus more adequately compensate for the effects of wind loads or climatic loads, in particular it can more adequately compensate for high temperatures which cause the glass sheets 1, 2 to expand, as shown in FIG. 2.

To manufacture an insulating glazing unit, a bead of butyl 4, 5 is deposited between each longitudinal side 31, 32 of the spacer 3 and each glass sheet 1, 2. The bead of butyl both secures the spacer 3 to the glass sheets 1, 2, in order to seal the insulating glazing unit, and forms a first barrier to gas and water vapor.

The membranes or membrane parts 61, 62 need not adhere to the longitudinal sides 31, 32 of the body of the spacer 3, apart from along the hinge line of the hinge. However, preferably, the membranes or membrane parts 61, 62 adhere very weakly to the longitudinal sides 31, 32 of the body of the spacer 3 before the spacer 3 is fitted between two glass sheets. This makes assembly of the insulating glazing unit easier, in particular it makes it easier to deposit the bead of butyl 4, 5 on the membranes or membrane parts 61, 62 and it makes it easier to apply the membranes or membrane parts coated with the bead of butyl 4, 5 to the glass sheets 1, 2. It also makes it easier to manufacture, store, and transport the interlayers without damaging the membrane, which, otherwise, risks being torn.

Once the insulating glazing unit has been manufactured, the bond strength between the bead of butyl 4, 5 and each membrane or membrane part 61, 62 is strictly greater than the bond strength between each membrane or membrane part 61, 62 and the longitudinal sides 31, 32 of the body of the spacer 3. Thus, each membrane or membrane part 61, 62 preferably adheres very weakly to the longitudinal sides 31, 32 of the body of the spacer 3, by virtue, for example, of a primerless polyurethane hotmelt adhesive or by virtue of any other polymer that weakly bonds and that does not degas so as not to pollute the interior of the insulating glazing unit. Thus, after fitting, the slightest deformation of the insulating glazing unit, due to wind loads or climatic loads, causes the membranes or membrane parts 61, 62 to debond from the longitudinal sides 31, 32 of the body of the spacer 3, apart from along the hinge line of the hinge. As soon as the insulating glazing unit is subjected to the slightest deformation, the membranes or membrane parts 61, 62, by being articulated to the longitudinal sides of the body of the spacer 3, thus compensate for the deformation of the glass sheets 1, 2 by following the movements of the glass sheets, thus preventing the bead of butyl 4, 5 from being damaged.

After manufacture of the spacer, if the membranes or membrane parts do not adhere at all to the longitudinal sides of the body, or after the slightest deformation of the glazing unit, if the membranes or membrane parts adhere very weakly to the longitudinal sides of the body, each membrane or membrane part 61, 62 articulates with the body about an axis parallel to the longitudinal axis of the body, hinging with the body. Each membrane or membrane part 61, 62 may thus move between a position in which it lies against a longitudinal side 31, 32 of the body and a position in which it is at least partially moved apart from the longitudinal side 31, 32 of the body. Specifically, in the embodiment in FIG. 2, there is always at least one line of contact between the membranes or membrane parts and the longitudinal sides of the body, for the articulation.

The insulating glazing unit also comprises a mastic 8 which is placed between the glass sheets 1, 2 of the insulating glazing unit, between the edge of the spacer 3 oriented toward the exterior of the insulating glazing unit and the edge faces 10, 20 of the glass sheets 1, 2. The mastic 8 forms a second barrier sealing against gas and water vapor. The mastic 8 is for example a polyurethane, polysulfide or silicone mastic.

The body of the spacer 3 is preferably a hollow profile filled with desiccant 7 so that moisture that might be contained inside the insulating glazing unit can be absorbed.

The body of the spacer 3 is preferably made of metal, for example of aluminum or steel, or of plastic, or even of a composite such as the composite sold by BASF under the Trademark LURAN, the composite comprising styrene acrylonitrile (SAN) and glass fibers.

FIGS. 3 and 4 show a cross-sectional view of a spacer 3 according to other embodiments of the invention.

In these embodiments the membranes or membrane parts 61, 62 are accordion- or bellows-shaped.

In the embodiment in FIG. 3, only one part of the membrane or membrane part has an accordion or bellows shape, the accordion or bellows having a single fold.

In the embodiment in FIG. 4, the membrane or membrane part has an accordion or bellows shape, the accordion or bellows having a plurality of folds.

The accordion or bellows shape allows the membrane or membrane part 61, 62 to extend under the effect of a deformation of the insulating glazing unit, thereby allowing it to follow the movements of the glass sheets more closely, both in expansion and in contraction. This prevents the articulation between the membrane and the longitudinal side of the body, or between the membrane part and the additional part of the membrane 6, from being placed under a too great stress, thereby preventing the membrane or membrane part from tearing.

Before the spacer is fitted in an insulating glazing unit, the folds of each membrane or membrane part 61, 62 may adhere to one another very weakly in order to make assembly of the insulating glazing unit easier. Once the insulating glazing unit has been manufactured, the slightest deformation of the insulating glazing unit, due to wind loads or climatic loads, causes the folds of each membrane or membrane part 61, 62 to debond from one another, apart from along the hinge lines of the folds. Thus, after the slightest deformation of the insulating glazing unit, the folds of the membranes or membrane parts 61, 62 compensate for the deformation of the glass sheets 1, 2 by following the movements of the glass sheets and thus prevent the bead of butyl 4, 5 from being damaged.

In the embodiment in FIG. 4, as in the embodiment in FIG. 2, there is always at least one line of contact between the membranes or membrane parts and the longitudinal sides of the body, for the articulation, as the line of contact between the membranes or membrane parts and the body is located at one end of the longitudinal sides of the body.

In the embodiment in FIG. 3, the contact line between the membranes or membrane parts and the body is shifted toward the bottom of the body. It is not necessary for there to be a point of contact between the membranes or membrane parts and the longitudinal sides of the body when the membranes or membrane parts move apart from the longitudinal sides of the body.

The invention also relates to a right-angle connector intended to be placed in a corner of an insulating glazing unit, between two spacers.

The connector comprises a right-angle body provided with two flanges connected via a corner. The end of each flange is intended to be inserted into a spacer and each flange and each corner is provided with two longitudinal sides. The connector also comprises two membranes or membrane parts each intended to be secured to a glass sheet of the insulating glazing unit. Each membrane or membrane part is intended to be articulated to the flanges and the corner about an axis parallel to the longitudinal axis of the flanges and the corner between a position in which the membrane or membrane part lies against a longitudinal side of the flanges and the corner and a position in which the membrane or membrane part is moved apart from the longitudinal side of the flanges and the corner. Each membrane or membrane part is accordion- or bellows-shaped, the accordion or bellows having at least one fold. Each membrane or membrane part is adapted to hinge with the right-angle body when the connector is fitted in an insulating glazing unit. The right-angle body forms a single hollow profile filled with desiccant. The right-angle body is made of metal, plastic or of a composite such as an SAN/glass-fiber composite. The membranes or membrane parts are made of metal and/or plastic.

The invention also relates to an insulating glazing unit comprising four spacers 3 according to the invention, and four connectors according to the invention, the spacers 3 being connected pairwise by a connector.

Thus the invention, in particular the spacer, allows insulating glazing units of any size providing optimized thermal performance to be fabricated, for example a triple glazing unit with two gas-filled cavities 19 mm in thickness and less than 80 cm in height and width, without running the risk of reducing their lifetime.

In addition, tests have shown that an insulating glazing unit equipped with spacers according to the invention is (about two times) better sealed than an insulating glazing unit equipped with spacers without an articulated membrane or membrane part.

1-15. (canceled)

16. A spacer for an insulating glazing unit, the spacer comprising:
a longitudinal body including two longitudinal sides and two membranes or membrane parts,
each membrane or membrane part configured to be secured to a glass sheet of the insulating glazing unit, and
each membrane or membrane part configured to be articulated to the body about an axis parallel to the longitudinal axis of the body between a position in which the membrane or membrane part lies against a longitudinal side of the body and a position in which the membrane or membrane part is at least partially spaced apart from the longitudinal side of the body.

17. The spacer as claimed in claim 16, in which each membrane or membrane part is accordion-shaped or bellows-shaped, the accordion or bellows having at least one fold.

18. The spacer as claimed in claim 16, in which each membrane or membrane part is configured to form a hinge with regard to the body when the spacer is fitted in an insulating glazing unit.

19. The spacer as claimed in claim 16, in which the body is a hollow profile filled with desiccant.

20. The spacer as claimed in claim 16, in which the body is made of metal or plastic or of a composite.

21. The spacer as claimed claim 16, in which the membranes or membrane parts are made of metal and/or plastic.

22. A right-angle connector for connecting two spacers of an insulating glazing unit, the connector comprising:
a right-angle body including two flanges connected via a corner, an end of each flange configured to be inserted into a spacer and each flange and each corner including two longitudinal sides, and two membranes or membrane parts each configured to be secured to a glass sheet of the insulating glazing unit,
each membrane or membrane part configured to be articulated to the flanges and the corner about an axis parallel to the longitudinal axis of the flanges and of the corner between a position in which the membrane or membrane part lies against a longitudinal side of the flanges and the corner and a position in which the membrane or membrane part is at least partially spaced apart from the longitudinal side of the flanges and the corner.

23. The connector as claimed in claim 22, in which each membrane or membrane part is accordion-shaped or bellows-shaped, the accordion or bellows having at least one fold.

24. The connector as claimed in claim 22, in which each membrane or membrane part is configured to form a hinge with regard to the right-angle body when the connector is fitted in an insulating glazing unit.

25. The connector as claimed in claim 22, in which the right-angle body forms a single hollow profile filled with desiccant.

26. The connector as claimed in claim 22, in which the right-angle body is made of metal or plastic or of a composite.

27. The connector as claimed in claim 22, in which the membranes or membrane parts are made of metal and/or plastic.

28. An insulating glazing unit comprising:
at least two glass sheets;
at least one spacer as claimed in claim 16, each membrane or membrane part being secured to one of the glass sheets of the insulating glazing unit;
a bead of butyl between each membrane or membrane part and a glass sheet;
a bond strength between the bead of butyl and each membrane or membrane part being strictly greater than a bond strength between each membrane or membrane part and longitudinal sides of the body of the spacer.

29. The insulating glazing unit as claimed in claim 28, further comprising mastic placed between the glass sheets between an edge of the spacer oriented toward an exterior of the insulating glazing unit and edge faces of the glass sheets.

30. The insulating glazing unit as claimed in claim 28, comprising four spacers and four connectors, the spacers being connected pairwise by a connector.
